(19) United States
(12) Patent Application Publication
(10) Pub. No.: US 2013/0294465 A1
(43) Pub. Date: Nov. 7, 2013

(54) HIGHLY EFFICIENT 3rd HARMONIC GENERATION IN Nd: YAG LASER

(71) Applicants: Chao Chang, San Jose, CA (US); Laurence E. Cramer, Mountain View, CA (US)

(72) Inventors: Chao Chang, San Jose, CA (US); Laurence E. Cramer, Mountain View, CA (US)

(73) Assignee: CONTINUUM

(21) Appl. No.: 13/887,009

(22) Filed: May 3, 2013

Related U.S. Application Data
(60) Provisional application No. 61/643,676, filed on May 7, 2012.

(51) Int. Cl. H01S 3/108

(52) U.S. Cl. CPC H01S 3/108
USPC 372/10; 372/22

(57) ABSTRACT

The specification and drawings present an apparatus and a method for intra-cavity harmonic generation in lasers such as solid-state lasers using a multi-resonance cavity with meniscus lenses for focusing corresponding wavelength radiation components on non-linear optical elements such as non-linear optical crystals using type I or type II phase-matching for significantly increasing efficiency of the harmonic conversion and output powers of generated harmonics. Using only type I or only type II phase-matching for all non-linear crystals may eliminate the requirement of linear-polarization on the fundamental laser wavelength generation. For example, a highly efficient UV Nd:YAG laser at 355 nm (a third harmonic of the fundamental wavelength of 1064 nm for the Nd:YAG laser) using intra-cavity triple resonance cavity and meniscus lenses has been developed using embodiments described herein.

### CROSS REFERENCE TO RELATED APPLICATIONS

This application claims priority to a provisional application Ser. No. 61/643,676 filed on May 7, 2012.

### TECHNICAL FIELD

The exemplary and non-limiting embodiments relate generally to laser resonators and more specifically to intra-cavity harmonic generation in lasers.

### BACKGROUND ART

This section is intended to provide a background or context to the embodiments disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

The ultraviolet (UV) laser is a vital tool in industrial applications and scientific research. While relatively low power TEM₀₀ UV lasers have found numerous applications such as via-hole drilling, memory repair, manufacturing of solar cells and most recently high brightness LEDs (light emitting diodes), there is a growing demand for high power multimode UV lasers as well, in applications such as thin film patterning, lithography, laser annealing, particle image velocimetry planar laser induced fluorescence and the like (for example, see Benjamin Bohm, Christof Heeger, Robert L. Gordon, Andreas Dreizler, “New Perspectives on Turbulent Combustion: Multi-Parameter High-Speed Planar Laser Diagnostics,” Flow, Turbulence Combust. 86, 313-341 (2011)).

A conventional method for intra-cavity third harmonic generation (THG) with a wavelength of 355 nm in Nd:YAG lasers requires having linearly polarized fundamental optical radiation at a wavelength of 1064 nm. Such configuration 10 shown in FIG. 1 comprises a two-stage THG scheme using type I phase matching with a crystal 12 for a second harmonic generation in frequency domain ω+ω→2ω, where ω is a fundamental laser frequency, and type II phase matching with a crystal 14 for a third harmonic generation ω+2ω→3ω. But the circulating linearly polarized fundamental radiation (or optical radiation) is a subject to substantial attenuation due to depolarization loss in the Nd:YAG rod 16, especially for multimode lasers. To remedy the polarization loss, a quarter waveplate 18 and a thin film polarizer (TFP) 20 were used (e.g., see David R. Dudley, Oliver Mehl, Gary Y. Wang, Ezra S. Allee, Henry Y. Pang, Norman Hodgson, “Q-switched diode pumped Nd:YAG rod laser with output power of 420 W at 532 nm and 160 W at 355 nm,” Proc. of SPIE 7193, 71930Z-1 (2009), and Jianghua Ji, Xiaolei Zhu, Shutao Dai, Chunyu Wang, “Depolarization loss compensated resonator for electro-optic Q-switched solid-state laser,” Opt. Commun 270, 301-304 (2007)). The TFP 20 in this schematic is used as a beam splitter.

In FIG. 1, one beam (transmitted through a beamsplitter 20 and reflected from a beam splitter 11 is used as the harmonic leg, and another beam is simply retro-reflected back (from a high reflection minor 22) to the cavity through the TFP 20 and circulated to the harmonic leg by polarization switching after double passing the quarter waveplate 18. Moreover, mirrors 24 and 26 are high reflection minors, element 15 is a beamsplitter to provide outputs at 355 and 532 nm (third and second harmonics respectively), and element 28 is a Q-switch (e.g., acuosto-optic or electro-optical modulator). The method shown in FIG. 1 suffers power loss as a result of reduced transmission through the TFP 20 and the depolarization in the Nd:YAG rod. In addition, the output of 532 nm (second harmonic) reduces the overall conversion efficiency from 1064 nm (fundamental) to 355 nm (third harmonic). Also this method increases cavity complexity, thus compromising laser reliability.

### SUMMARY

The purpose and advantages of the invention will be set forth in and apparent from the description that follows. Additional advantages of the invention will be realized and attained by the devices, systems and methods particularly pointed out in the written description and claims hereof, as well as from the appended drawings.

In a first aspect, an apparatus comprising: a laser resonator comprising a back reflection minor, an output optical coupler and multiple resonator branches, the laser resonator at least further comprises: one or more gain components in a first branch of the multiple resonator branches configured to generate a first wavelength radiation; a first non-linear optical component in a second branch of the multiple resonator branches configured to generate a second wavelength radiation related to the first optical frequency radiation in a predefined manner; a second non-linear optical component in a third branch of the multiple resonator branches configured to generate a third wavelength radiation related to one or more of the first and second wavelength radiations in a further predefined manner; a first meniscus lens located between the first and second branches and configured to transmit the first wavelength radiation and to reflect the second wavelength radiation, and configured to focus the first wavelength radiation on the first non-linear optical component; and a second meniscus lens located between the second and third branches and configured to transmit the first and the second wavelength radiations, and to reflect the third wavelength radiation, and configured to focus the first and second wavelength radiations on the second non-linear optical component, wherein the output optical coupler is configured to reflect at least the first and second wavelength radiations.

In a second aspect, a method comprising: providing a laser comprising: a laser resonator comprising a back reflection minor, an output optical coupler and multiple resonator branches, the laser resonator further comprises: one or more gain components in a first branch of the three resonator branches configured to generate a first wavelength radiation; a first non-linear optical component in a second branch of the multiple resonator branches configured to generate a second wavelength radiation related to the first optical frequency radiation in a predefined manner; a second non-linear optical component in a third branch of the multiple resonator branches configured to generate a third wavelength radiation related to one or more of the first and second wavelength radiations in a further predefined manner; a first meniscus lens located between the first and second branches and configured to transmit the first wavelength radiation and to reflect the second wavelength radiation, and configured to focus the first wavelength radiation on the first non-linear optical component; and a second meniscus lens located between the second and third branches and configured to transmit the first and the second wavelength radiations, and to reflect the third wavelength radiation, and configured to focus the first and second wavelength radiations on the second non-linear optical component, wherein the output optical coupler is configured to reflect at least the first and second wavelength radiations and to transmit the third wavelength radiation; providing an optical power pumping to the one or more gain components and generating the first wavelength radiation in the laser resonator; and generating the third wavelength radiation in the third branch of the laser resonator using one or more of the generated first and second wavelength radiations in the corresponding first and second branches and providing the third wavelength radiation by the laser through the output optical coupler.

In a third aspect, an apparatus, comprising: a laser resonator comprising a back reflection mirror, an output optical coupler and multiple resonator branches between the back reflection mirror and the output optical coupler, the laser resonator further comprises: one or more gain components in a first branch of the multiple resonator branches configured to generate a first wavelength radiation; one or more non-linear optical elements, each of the one or more non-linear optical elements is located in a corresponding branch of the multiple resonator branches, where each corresponding branch comprises only one of the one or more non-linear optical elements, and wherein each of the one or more non-linear optical elements is configured to generate a corresponding wavelength radiation related to the first wavelength radiation in a predefined manner and having a wavelength different from wavelengths of radiation generated by any other of the one or more non-linear optical elements; one or more meniscus lenses, each located in between two branches of the multiple resonator branches, where each meniscus lens is configured to focus an optical radiation on a corresponding non-linear optical component of the one or more non-linear optical components, and further configured to transmit radiation of one or more wavelengths generated in the laser resonator and to reflect radiation of other one or more wavelengths generated in the laser resonator based on a predetermined criterion, wherein the output optical coupler is configured to transmit a wavelength generated in one branch of the multiple resonator branches, the one branch comprises the output optical coupler, and to reflect all other radiations having one or more wavelengths generated in the laser resonator.

### BRIEF DESCRIPTION OF THE DRAWINGS

The accompanying drawings illustrate various non-limiting, illustrative, inventive aspects in accordance with the present disclosure:

FIG. 1 is an illustrative example of a conventional method for intra-cavity third harmonic generation;

FIG. 2 depicts an illustrative example of a general schematic of a laser resonator for practicing exemplary embodiments presented herein;

FIGS. 3a and 3b are illustrative examples of a Nd:YAG laser resonator for practicing exemplary embodiments presented herein;

FIGS. 4 and 5 are illustrative examples comparing collected data for two configurations of type-I (type-I ω+ω→2ω; type-I ω+2ω→3ω) and type-II (type-II ω+ω→2ωType-II ω+2ω→3ω) harmonic generation processes measured using an exemplary embodiment depicted in FIG. 3b;

FIGS. 6-8 show examples of beam parameters for the type-II harmonic generation process measured using an exemplary embodiment depicted in FIG. 3b; and

FIG. 9 is a flow chart illustrating implementation of various embodiments.

### DETAILED DESCRIPTION

The present invention is now described more fully with reference to the accompanying drawings, in which illustrated embodiments of the present invention are shown. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. Any publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

An apparatus and a method are presented for intra-cavity harmonic generation in lasers such as solid-state lasers using a multi-resonance cavity with meniscus lenses for focusing corresponding wavelength radiation (or optical radiation) components on non-linear optical elements such as non-linear optical crystals using type I or type II phase-matching for significantly increasing efficiency of the harmonic conversion and output powers of generated harmonics. Using only type I or only type II phase-matching for all non-linear crystals may eliminate the requirement of linear-polarization on the fundamental laser wavelength generation. For example, a highly efficient UV (ultra violet) Nd:YAG laser at 355 nm (a third harmonic of the fundamental wavelength of 1064 nm for the Nd:YAG laser) using intra-cavity triple resonance cavity and meniscus lenses has been developed using embodiments described herein.

In an embodiment, a harmonic generation may be achieved using a laser resonator comprising a back reflection minor, an output optical coupler and multiple resonator branches (for example three branches for the third harmonic generation), where the laser resonator may further comprise: one or more gain components (such as laser rods in solid-state lasers) in a first branch of the multiple resonator branches configured to generate a first (fundamental) wavelength radiation. A three-branch laser resonator which can be used for the third and fourth harmonic generation may further comprise:
a first non-linear optical component in a second branch of the multiple resonator branches configured to generate a second wavelength radiation related to the first optical frequency radiation in a predefined manner (e.g., second harmonic of the fundamental frequency, ω+ω→2ω, where the second wavelength is a half of the fundamental wavelength);
a second non-linear optical component in a third branch of the multiple resonator branches configured to generate a third wavelength radiation related to the first and second wavelength radiation in a further predefined manner (e.g., a third or fourth harmonic of the fundamental wavelength, ω+2ω→3ω or 2ω+2ω→4ω);
a first meniscus lens located between the first and second branches and configured to transmit the first wavelength radiation and to reflect the second wavelength radiation, and configured to focus the first wavelength radiation on the first non-linear optical component; and
a second meniscus lens located between the second and third branches and configured to transmit the first and the second wavelength radiations, and to reflect the third wavelength radiation, and configured to focus the first and second wavelength radiations on the second non-linear optical component,

wherein the output optical coupler is configured to reflect at least the first and second wavelength radiations and transmit the third wavelength radiation (e.g., a third or fourth harmonic output).

It is appreciated that when an optical component like meniscus lens is transparent to a certain wavelength it may imply using antireflection (AR) coating for that specific wavelength. Since non-linear optical components in general may be transparent to all wavelengths of interest, a broadband AR coating may be used with these components as well.

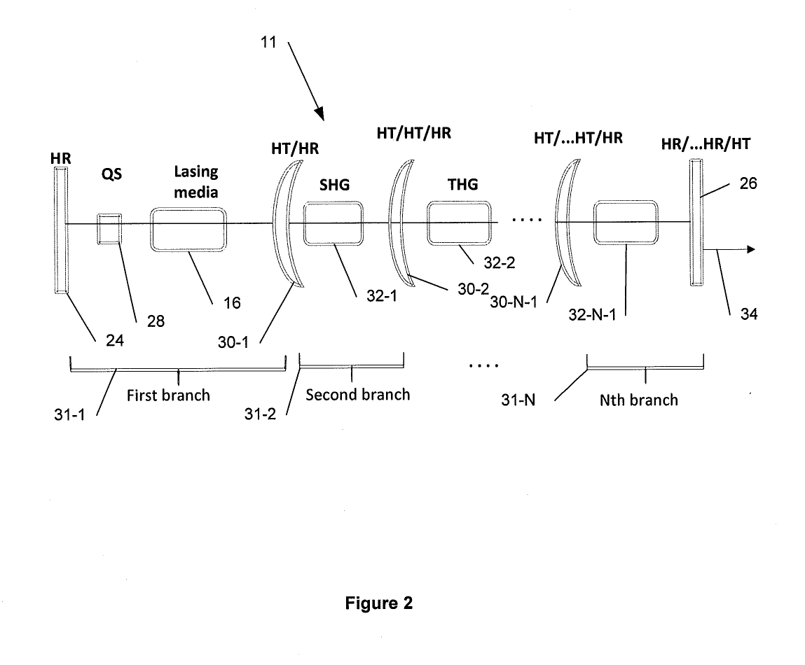

By adding a fourth branch comprising a third non-linear optical component and a third meniscus lens may facilitate generation of higher order harmonics (e.g., fifth and sixth harmonics of the fundamental laser wavelength). Even higher harmonics may be generated by adding more branches as further discussed in reference to FIG. 2.

For example, the fifth harmonic may be generated from the 4th harmonic (fourth wavelength) and the first harmonic (fundamental wavelength) formed in the third and first branches as 4ω+ω→5ω. A sixth harmonic may be generated from the 4th and 2nd harmonics formed in the third and second branches as 4ω+2ω→6ω.

In this embodiment a third meniscus lens may be located between the third and fourth branches and configured to transmit the first, second and third wavelength radiations and to reflect the fourth wavelength radiation, and also configured to focus the first, second and third wavelength radiations on the third non-linear optical component. In this embodiment the output optical coupler may be configured to reflect the first, second and third wavelength radiations and to transmit the fourth wavelength radiation (fifth or sixth harmonic).

It is appreciated and understood that various embodiments described herein may be applicable to different types of lasers such as solid state lasers, gas lasers, semiconductor lasers and the like in a continuous wave (CW) pumped mode of operation. For higher efficiency of the harmonic generation, pulsing mode of the laser operation may be used. Pulsing may be provided using Q-switching (for example using electro-optical or acousto-optical modulators), mode-locking, direct current modulation and the like.

FIG. 2 shows a general schematic of a laser resonator 11 for practicing exemplary embodiments presented herein. The resonator 11 comprises a back reflection minor 24, an output optical coupler 26 and N resonator branches 31-1, 31-2, . . . 31-N between the back reflection minor 24 and the output optical coupler 26, N is a finite integer of a value of two or more. A Q-switch modulator (QS) 28 in the first branch 31-1 may be used (optionally) for creating higher peak power optical pulses.

The laser resonator 11 may further comprise one or more gain components 16 in a first branch 31-1 formed between the back reflection mirror 24 and a first meniscus lens 30-1 and configured to generate a first (fundamental) wavelength radiation. The one or more gain components may be laser rod(s) pumped by arc lamp(s) or semiconductor laser diode array(s) in solid-state lasers like Nd:YAG. In gas lasers it may be a hermetically sealed gas chamber with outside windows comprising the back minor 24 and a first meniscus lens 30-1.

The laser resonator 11 may further comprise one or more non-linear optical elements 32-1, 32-2, . . . , 32-N−1; each of these non-linear optical elements being located in a corresponding branch 31-2, . . . or 31-N of the multiple resonator branches (each corresponding branch comprises only one of the one or more non-linear optical elements), and wherein each of the one or more non-linear optical elements 32-1, 32-2, . . . , or 32-N−1 is configured to generate a corresponding wavelength radiation related to the first wavelength radiation (or frequency) in a predefined manner and having a wavelength different from wavelengths of radiation generated by any other of the one or more non-linear optical elements.

The laser resonator 11 may further comprise one or more meniscus lenses 30-1, 30-2, . . . , 30-N−1, each located in between two branches of the multiple resonator branches 31-1, 31-2, . . . , 31-N, where each meniscus lens is configured to focus an optical radiation on a corresponding non-linear optical component (e.g., meniscus lens 30-1 focusing on the non-linear optical crystal 32-1, meniscus lens 30-2 focusing on the non-linear optical crystal 32-2 and so on). Also each of the meniscus lenses 30-1, 30-2, . . . , 30-N−1 may be further configured to transmit radiation of one or more wavelengths generated in the laser resonator 11 and to reflect other one or more wavelengths generated in the laser resonator 11 based on a predetermined criterion. For example, the meniscus lens 30-1 may be transparent (e.g., using AR coating) for the radiation having the first (fundamental) wavelength/frequency, but reflective to the radiation of the second harmonics (second wavelength) in order to form a second harmonic cavity between the meniscus lens 30-1 and the output coupler 26. Similarly, the meniscus lens 30-2 may be transparent (e.g., using AR coating) to the radiation having the first (fundamental) wavelength/frequency and to the radiation having the second wavelength (second harmonic) generated by the non-linear optical component 32-1, but reflective to the radiation having a third wavelength (third harmonic) generated by the non-linear optical component 32-2 in order to form a resonant cavity between the meniscus lens 30-2 and the output coupler 26 for generating the third wavelength (e.g., corresponding the third or fourth harmonic frequency of the fundamental frequency), and so on. Finally, the last meniscus lens 30-N−1 may be transparent to the radiations of all wavelengths generated in the laser resonator 11 except for one, which has a desired output wavelength generated, for example, by the last non-linear optical component 32-N−1.

Then the output optical coupler 26 may be configured to transmit an output radiation (beam) 34 having a wavelength generated in one (e.g., the last Nth branch) of the multiple resonator branches and to reflect all other radiations of the one or more wavelengths generated in the laser resonator.

For example, if the multiple resonator branches 31-1, 31-2, . . . , 31-N− comprise two branches 31-1 and 31-2, the one or more non-linear optical elements comprises only one non-linear optical element 32-1 in the second branch 31-2, and the one or more meniscus lenses comprise one meniscus lens 30-1 located between the first and second branches (31-1 and 31-2 respectively), so that a second wavelength generated in the second branch equals a half of a wavelength of the first wavelength radiation (second harmonic) and is transmitted by the output optical coupler 26.

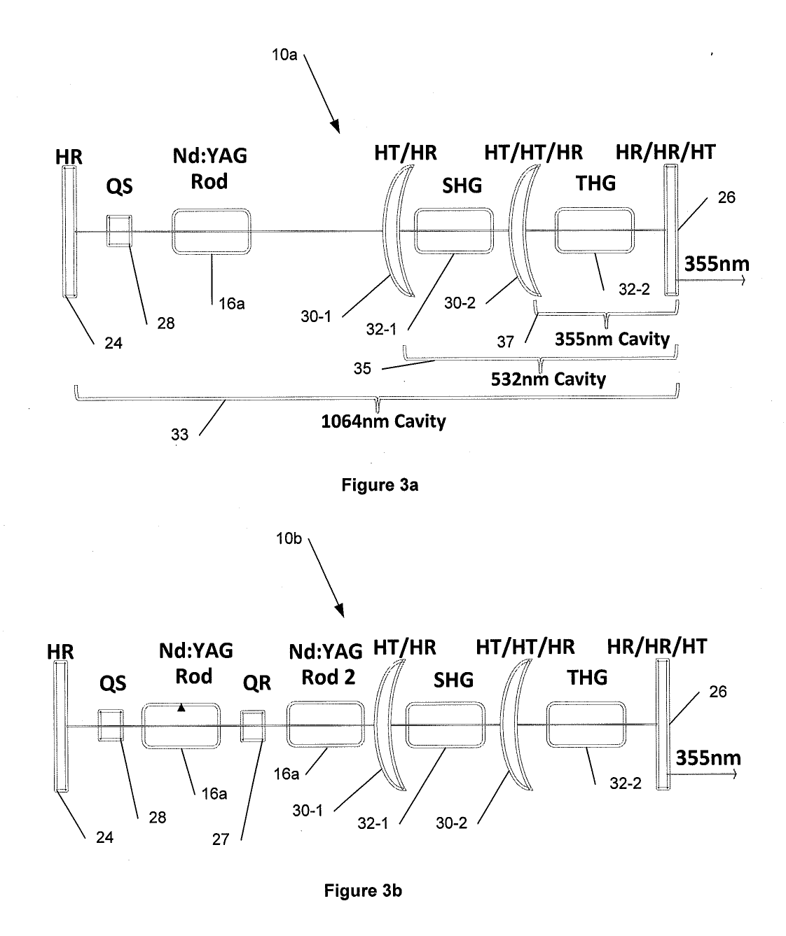

FIGS. 3a-3b and 4-8 provide further illustrations for applying exemplary embodiments in reference to solid-state lasers and more specifically to CW pumped Q-switched Nd:YAG lasers. In general the various embodiments described herein are applicable to the solid-state lasers having gain lasing media/rods which may include but are not limited to Nd:YAG, Nd:YLF, Nd:YVO4, Nd:GdVO4, Nd:Glass, Yb:YAG, Yb:KGW, Yb:KYW, Yb:CaF2, Yb:Glass, Er:YAG, Tm:YAG, Ho:YAG, etc.

Examples of non-linear optical crystals that may be cut to Type I and/or Type II configurations may include but are not limited to: LBO (lithium triborate), BBO (barium borate), CBO (cesium borate), CLBO (cesium lithium borate), YCOB (yttrium calcium oxyborate), KDP (potassium dihydrogen phosphate), KTP (potassium titanyl phosphate), DLAP (deuterated L-arginine phosphate), LiIO₃ (lithium iobate), LiNbO₃ (lithium niobate) and the like

FIGS. 3a and 3b show examples of Nd:YAG laser resonators 10a and 10b respectively for generating a third harmonic UV radiation with the wavelength of 355 nm out of a fundamental wavelength of 1064 nm using a triple resonance setup. FIGS. 3a and 3b are simplified versions of the general example of FIG. 2 with N=3. The laser resonators 10a and 10b are similar except that in FIG. 3b, there are two Nd:YAG rods 16a (dual rods) in the laser resonator 10b, where in the laser resonator 10a in FIG. 3a there is only one rod 16a. In that regard in the example shown in FIG. 3b, a 90° quartz rotator (QR) 27 is further inserted between the dual rods 16a for birefringence compensation (which may be thermally induced). A Q-switch modulator (QS) 28 such as acousto-optical modulator is used (optionally) for creating higher peak power optical pulses.

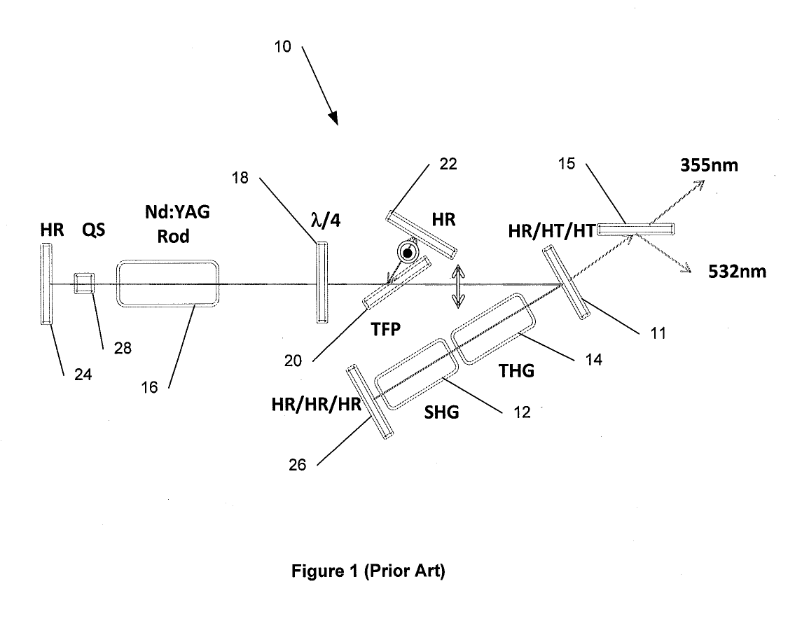

For both examples shown in FIGS. 3a and 3b, two novel configurations using Type-I (Type-I ω+ω→2ω; Type-I ω+2ω→3ω) and Type-II (Type-II ω+ω→2ω; Type-II ω+2ω→3ω) harmonic generation processes may be used, which can eliminate the requirement for linear-polarization of the radiation having the fundamental wavelength (1064 nm) and its consequent power loss without using complex multi-leg cavities (e.g., as shown in FIG. 1).

Each of the Nd:YAG rods 16a may be side-pumped by a diode module at 808 nm with up to 525 W pump power. By inserting a dichroic HT/HR meniscus lens 30-1 (transmitting 1064 nm and reflecting 532 nm optical radiation) and a trichroic HT/HT/HR meniscus lens 30-2 (transmitting 1064 and 532 nm, and reflecting 355 nm optical radiation), collinear triple resonances at 1064/532/355 nm with corresponding resonant cavities 33, 35 and 37 for corresponding wavelengths 1064, 532 and 355 nm (as shown in FIG. 3a) are formed in the laser resonator 10a or 10b. The mirror 24 is a HR (high reflector) minor for 1064 nm wavelength, and the output coupler minor 26 reflects 1064 and 532 nm wavelengths and transmits UV wavelength 355 nm. The conversion efficiency to the UV radiation having the wavelength of 355 nm is therefore greatly enhanced.

In the Type-I configuration, while the 532 nm light is configured to be phase-matched with one polarization component of un-polarized 1064 nm wavelength optical radiation, the UV 355 nm light is phase-matched with the other perpendicular polarization component of the fundamental wavelength 1064 nm. The unconverted 1064 nm light is circulated back and forth, and is redistributed between these two polarization components through depolarization of the Nd:YAG rods naturally. A similar mechanism occurs in the type-II configuration, except the type-II second harmonic generation involves both polarization components of the optical radiation at 1064 nm

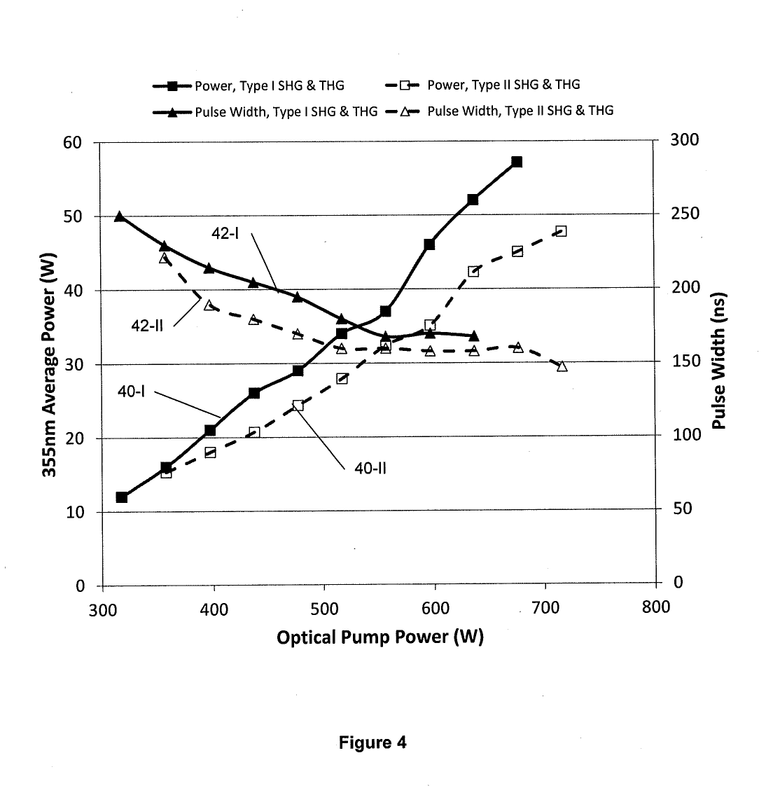

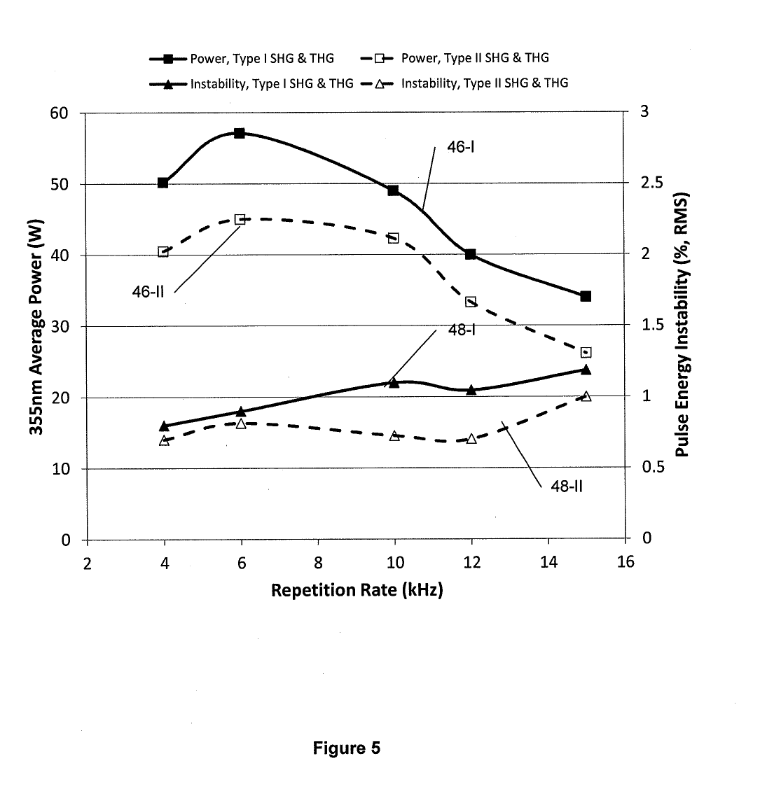

FIGS. 4 and 5 show a comparison data for two configurations of type-I (type-I ω+ω→2ω; type-I ω+2ω→3ω) and type-II (type-II ω+ω→2ω; Type-II ω+2ω→3ω) harmonic generation processes measured using the setup of FIG. 3b.

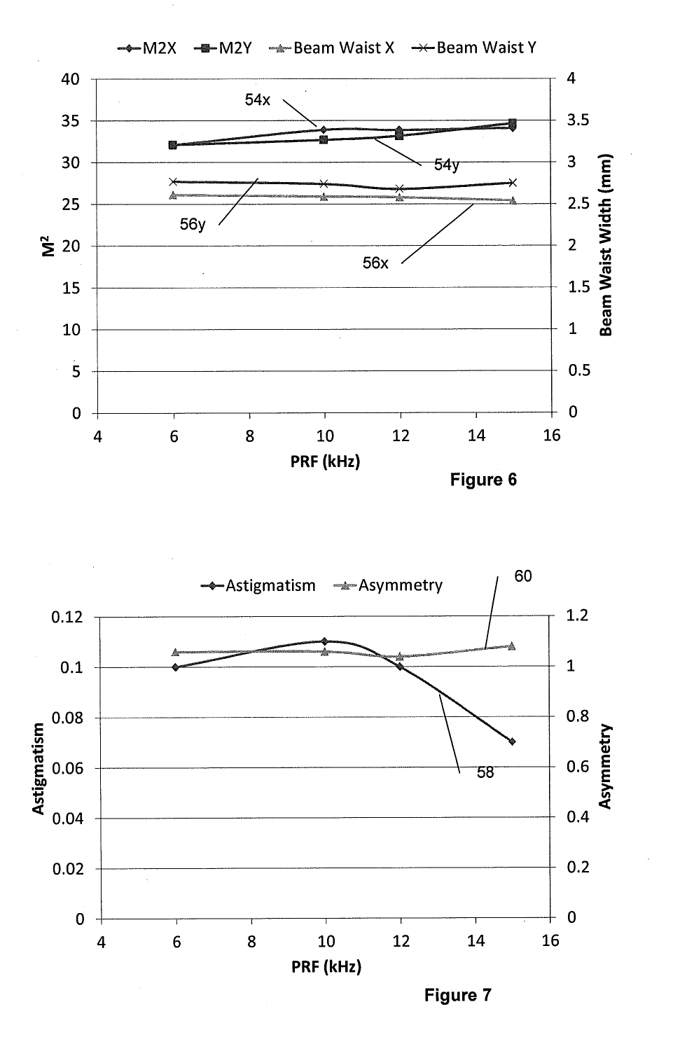

FIG. 4 shows a dependence of the generated 355 nm third harmonic average power (left vertical scale) and pulse width (right vertical scale) as a function of the optical pump power at 6 kHz Q-Switching rate. It is seen from FIG. 4 that the generated 355 nm optical radiation for the type I harmonic generation processes (see curve 40-I) is higher than for the type II harmonic generation processes (see curve 40-II). However, the pulse width for the type II harmonic generation process (see curve 42-II) is shorter than for the type I harmonic generation process (see curve 42-I). Also the beam quality for the type II harmonic generation process (see FIGS. 6-8) is better than for the type I harmonic generation process.

FIG. 5 shows a dependence of the generated 355 nm third harmonic average power (left vertical scale) and pulse energy stability (right vertical scale) as a function of laser repetition rate. It is seen from FIG. 5 that the UV conversion in the type-I configuration (see curve 46-I) is again approximately 20% more efficient than that of the type-II case (see curve 46-II) due to a higher nonlinear coefficient. The overall optical efficiency is about 10% in the type-II configuration yielding an output power of up to 90 W at 6 kHz at 355 nm. This result is noticeably higher than 6% optical efficiency previously reported (see David R. Dudley, Oliver Mehl, Gary Y. Wang, Ezra S. Allee, Henry Y. Pang, Norman Hodgson, “Q-switched diode pumped Nd:YAG rod laser with output power of 420 W at 532 nm and 160 W at 355 nm,” Proc. of SPIE 7193, 71930Z-1 (2009)).

FIGS. 6-8 show examples of beam measured parameters for the type-II harmonic generation processes measured using the setup of FIG. 3b for the 355 nm UV laser power.

FIG. 6 shows dependence of M² parameter also called a beam quality factor or a beam propagation factor (left vertical scale, curves 54x and 54y) and a beam waist width (right vertical scale, curves 56x and 56y) in x and y directions respectively as a function of PRF (pulse repetition frequency) for the generated 355 nm third harmonic laser beam. It is seen from FIG. 6 that the beam properties only change by 5% in the range of the laser repetition rates from 6 to 15 kHz.

FIG. 7 shows dependence of astigmatism (left vertical scale, curve 58) and asymmetry (right vertical scale, curve 60) as a function of PRF (pulse repetition frequency) for the generated 355 nm third harmonic laser beam. It is seen from FIG. 7 that the beam properties are good. For example, the asymmetry (curve 60) is close to 1 which is an attribute of a perfect round beam. The astigmatism is also insignificant (zero corresponds to absence of astigmatism for a perfectly focused laser beam).

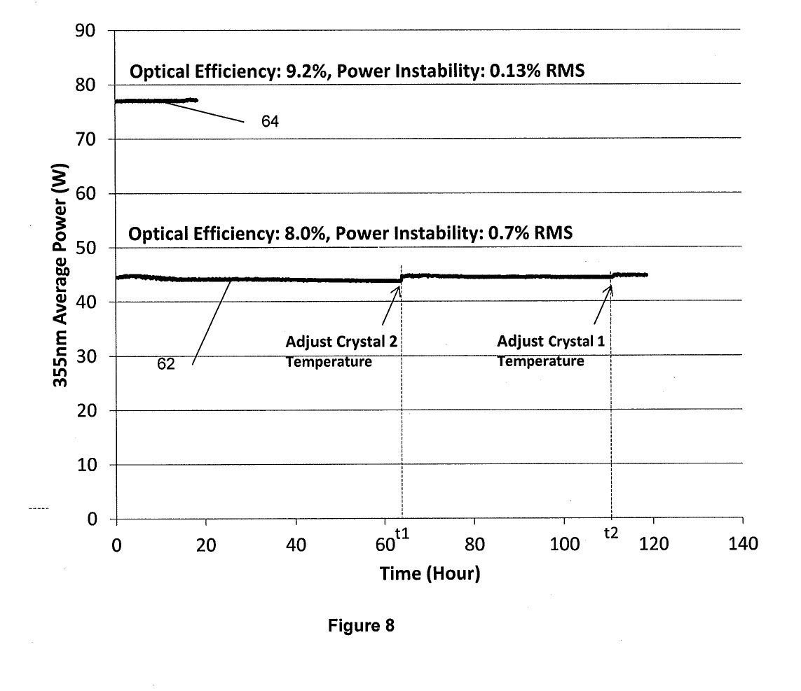

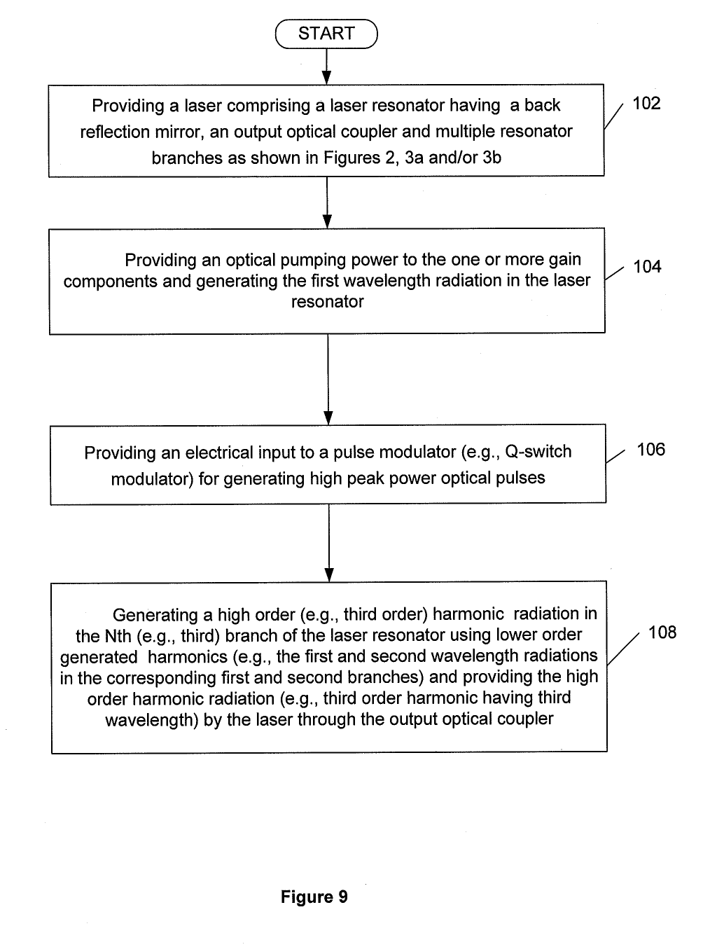

FIG. 8 shows results for a long term stability testing for the generated 355 nm third harmonic laser beam. Curve 62 corresponds to a 120 hour long-term test at a 45 W level for the 355 nm UV laser power. The power drift (around 0.7% RMS) may be compensated with a slight adjustment of nonlinear crystal phase matching temperatures at times t1 and t2 as shown in FIG. 8, which indicates that no deterioration of the UV power during the test was achieved. Curve 64 corresponds to another long term stability test at a 77 W level of the 355 nm UV laser power, where the power instability was found to be 0.13% RMS within 20 hours.

With reference now to FIG. 9, shown is a flow chart demonstrating implementation of the various illustrated embodiments. It is noted that the order of steps shown in FIG. 9 is not required, so in principle, the various steps may be performed out of the illustrated order. Also certain steps may be skipped, different steps may be added or substituted, or selected steps or groups of steps may be performed in a separate application following the embodiments described herein.

In a method according to the embodiment shown in FIG. 9, in a first step 102, a laser is provided, the laser comprising a laser resonator having a back reflection minor, an output optical coupler and multiple resonator branches as shown in FIGS. 2, 3a and/or 3b.

In a next step 104, an optical pumping power is applied to the one or more gain components of the resonator to generate the first wavelength radiation in the laser resonator.

In a next step 106, an electrical input is provided to a pulse modulator (e.g., Q-switch modulator) for generating higher peak power optical pulses (optional if pulse modulation is used).

In a next step 108, generating a high order (e.g., third order) harmonic radiation in the Nth (e.g., third) branch of the laser resonator using generated lower order harmonics (e.g., the first and second wavelength radiations formed in the corresponding first and second branches) and providing the high order harmonic radiation (e.g., a third order harmonic having a third wavelength) by the laser through the output optical coupler.

With certain illustrated embodiments described above, it is to be appreciated that various non-limiting embodiments described herein may be used separately, combined or selectively combined for specific applications.

Further, some of the various features of the above non-limiting embodiments may be used without the corresponding use of other described features. The foregoing description should therefore be considered as merely illustrative of the principles, teachings and exemplary embodiments of this invention, and not in limitation thereof. It is to be understood that the above-described arrangements are only illustrative of the application of the principles of the illustrated embodiments.

Numerous modifications and alternative arrangements may be devised by those skilled in the art without departing from the scope of the illustrated embodiments, and the appended claims are intended to cover such modifications and arrangements.

What is claimed is:

1. An apparatus, comprising:
a laser resonator comprising a back reflection mirror, an output optical coupler and multiple resonator branches, the laser resonator at least further comprises:
one or more gain components in a first branch of the multiple resonator branches configured to generate a first wavelength radiation;
a first non-linear optical component in a second branch of the multiple resonator branches configured to generate a second wavelength radiation related to the first optical frequency radiation in a predefined manner;
a second non-linear optical component in a third branch of the multiple resonator branches configured to generate a third wavelength radiation related to one or more of the first and second wavelength radiations in a further predefined manner;
a first meniscus lens located between the first and second branches and configured to transmit the first wavelength radiation and to reflect the second wavelength radiation, and configured to focus the first wavelength radiation on the first non-linear optical component; and
a second meniscus lens located between the second and third branches and configured to transmit the first and the second wavelength radiations, and to reflect the third wavelength radiation, and configured to focus the first and second wavelength radiations on the second non-linear optical component,
wherein the output optical coupler is configured to reflect at least the first and second wavelength radiations.

2. The apparatus of claim 1, wherein the output optical coupler is configured to transmit the third wavelength radiation.

3. The apparatus of claim 1, wherein the back reflection mirror, the output optical coupler, the first and second non-linear optical elements, and one or more gain components have a common optical axis.

4. The apparatus of claim 1, wherein the laser resonator comprises two gain components in the first branch.

5. The apparatus of claim 1, wherein the second wavelength radiation is a second harmonic of the first wavelength radiation, such that a wavelength of the second wavelength radiation equals a half of a wavelength of the first wavelength radiation.

6. The apparatus of claim 1, wherein the third wavelength radiation is a third harmonic of the first wavelength radiation, such that a wavelength of the third wavelength radiation equals one third of a wavelength of the first wavelength radiation.

7. The apparatus of claim 1, wherein the third wavelength radiation is a fourth harmonic of the first wavelength radiation, such that a wavelength of the third wavelength radiation equals one fourth of a wavelength of the first wavelength radiation.

8. The apparatus of claim 1, wherein the apparatus comprises a solid-state laser.

9. The apparatus of claim 8, wherein the solid state laser is a Q-switched pulsed Nd:YAG laser, so that the laser resonator comprises a Q-switch modulator in the first branch.

10. The apparatus of claim 8, further comprises:
one or more semiconductor laser arrays configured to side-pump the one or more gain components.

11. The apparatus of claim 1, wherein the laser resonator further comprises:
a fourth branch of the multiple resonator branches;
a third non-linear optical component in the fourth branch configured to generate a fourth wavelength radiation related to the first, second and third wavelength radiations in another predefined manner; and
a third meniscus lens located between the second and third branches configured to transmit the first, second and third wavelength radiations and to reflect the fourth wavelength radiation, and configured to focus the first, second and third wavelength radiations on the third non-linear optical component,
wherein the output optical coupler is further configured to reflect the first, second and third wavelengths radiations and to transmit the fourth wavelength radiation.

12. The apparatus of claim 11, wherein the fourth wavelength radiation is a fifth harmonic of the first wavelength radiation, such that a wavelength of the fourth wavelength radiation equals one fifth of a wavelength of the first wavelength radiation.

13. The apparatus of claim 11, wherein the fourth wavelength radiation is a sixth harmonic of the first wavelength radiation, such that a wavelength of the fourth wavelength radiation equals one sixth of a wavelength of the first wavelength radiation.

14. The apparatus of claim 1, where a type II harmonic generation process is used for both the first and second non-linear optical components.

15. The apparatus of claim 1, where a type I harmonic generation process is used for both the first and second non-linear optical components.

16. A method comprising:
providing a laser comprising:
a laser resonator comprising a back reflection mirror, an output optical coupler and multiple resonator branches, the laser resonator further comprises:
one or more gain components in a first branch of the three resonator branches configured to generate a first wavelength radiation;
a first non-linear optical component in a second branch of the multiple resonator branches configured to generate a second wavelength radiation related to the first optical frequency radiation in a predefined manner;
a second non-linear optical component in a third branch of the multiple resonator branches configured to generate a third wavelength radiation related to one or more of the first and second wavelength radiations in a further predefined manner;
a first meniscus lens located between the first and second branches and configured to transmit the first wavelength radiation and to reflect the second wavelength radiation, and configured to focus the first wavelength radiation on the first non-linear optical component; and
a second meniscus lens located between the second and third branches and configured to transmit the first and the second wavelength radiations, and to reflect the third wavelength radiation, and configured to focus the first and second wavelength radiations on the second non-linear optical component,
wherein the output optical coupler is configured to reflect at least the first and second wavelength radiations and to transmit the third wavelength radiation;
providing an optical power pumping to the one or more gain components and generating the first wavelength radiation in the laser resonator; and
generating the third wavelength radiation in the third branch of the laser resonator using one or more of the generated first and second wavelength radiations in the corresponding first and second branches and providing the third wavelength radiation by the laser through the output optical coupler.

17. The method of claim 16, wherein the second wavelength radiation is a second harmonic of the first wavelength radiation, such that a wavelength of the second wavelength radiation equals a half of a wavelength of the first wavelength radiation.

18. The method of claim 16, wherein the third wavelength radiation is a third harmonic of the first wavelength radiation, such that a wavelength of the third wavelength radiation equals one third of a wavelength of the first wavelength radiation.

19. The method of claim 16, wherein the third wavelength radiation is a fourth harmonic of the first wavelength radiation, such that a wavelength of the third wavelength radiation equals one fourth of a wavelength of the first wavelength radiation.

20. An apparatus, comprising:
a laser resonator comprising a back reflection mirror, an output optical coupler and multiple resonator branches between the back reflection minor and the output optical coupler, the laser resonator further comprises:
one or more gain components in a first branch of the multiple resonator branches configured to generate a first wavelength radiation;
one or more non-linear optical elements, each of the one or more non-linear optical elements is located in a corresponding branch of the multiple resonator branches, where each corresponding branch comprises only one of the one or more non-linear optical elements, and wherein each of the one or more non-linear optical elements is configured to generate a corresponding wavelength radiation related to the first wavelength radiation in a predefined manner and having a wavelength different from wavelengths of radiation generated by any other of the one or more non-linear optical elements;
one or more meniscus lenses, each located in between two branches of the multiple resonator branches, where each meniscus lens is configured to focus an optical radiation on a corresponding non-linear optical component of the one or more non-linear optical components, and further configured to transmit radiation of one or more wavelengths generated in the laser resonator and to reflect radiation of other one or more wavelengths generated in the laser resonator based on a predetermined criterion,
wherein the output optical coupler is configured to transmit a wavelength generated in one branch of the multiple resonator branches, the one branch comprises the output optical coupler, and to reflect all other radiations having one or more wavelengths generated in the laser resonator.

21. The apparatus of claim 20, wherein the multiple resonator branches comprise two branches, the one or more non-linear optical elements comprises one non-linear optical element in a second branch of the two branches, and the one or more meniscus lenses comprise one meniscus lens located between the first and second branches, so that a second wavelength generated in the second branch equals a half of a wavelength of the first wavelength radiation and is transmitted by the output optical coupler.
